(19) United States
(12) Patent Application Publication
(10) Pub. No.: US 2009/0004495 A1
(43) Pub. Date: Jan. 1, 2009

(54) High weight percent gain (WPG) furfural-urea modification of wood

(76) Inventors: Marc Henry Schneider, Fredericton (CA); Jonathan Greer Phillips, Fredericton (CA)

Correspondence Address: Ralph A. Dowell of DOWELL & DOWELL P.C., 2111 Eisenhower Ave, Suite 406, Alexandria, VA, 22314, US

(21) Appl. No.: 11/892,260

(22) Filed: Aug. 21, 2007

Related U.S. Application Data
(60) Provisional application No. 60/929,510, filed on Jun. 29, 2007.

(51) Int. Cl. B32B 21/08

(52) U.S. Cl. 428/528; 427/393

(57) ABSTRACT

This invention provides methods of furfural-urea modification of wood, and more particularly the present invention relates to the impregnation, and polymerization of, furfural-urea formulations under conditions of high weight percent gain (WPG) into wood. Wood is modified by impregnating wood first with furfural, thereafter impregnating the wood with a solution of urea, water and an acidic catalyst for polymerizing the mixture of furfural and urea in the wood. The wood is then dried and cured at the same time.

### CROSS REFERENCE TO RELATED U.S. PATENT APPLICATIONS

This patent application relates to U.S. provisional patent application Ser. No. 60/929,510 filed on Jun. 29, 2007 entitled HIGH WEIGHT PERCENT GAIN (WPG) FURFURAL-UREA MODIFICATION OF WOOD, filed in English, which is incorporated herein in its entirety by reference.

### FIELD OF THE INVENTION

This invention relates to methods of furfural-urea modification of wood, and more particularly the present invention relates to the impregnation, and polymerization of, furfural-urea formulations under conditions that produce high weight percent gain (WPG) in wood in order to impart decay, marine borer and termite resistance and improve moisture resistance and mechanical properties.

### BACKGROUND OF THE INVENTION

Urea [(NH₂)₂CO] is a common organic chemical. It is a major component of urine. Reacted with formaldehyde, it forms a thermosetting urea-formaldehyde polymer (UF resins and polymers). The UF polymer has been used as a wood adhesive for many years, and is still the most widely used interior plywood and particleboard adhesive. In the 1940s, a prepolymer form was used as a water-diluted wood impregnant. There were commercial companies making the urea-wood composite (one trade name was “Uralloy”). Wood so treated dried with fewer defects than untreated wood. After the urea was polymerized inside the wood, the material was harder and more fire resistant. Its color was unchanged from untreated wood.

The urea treatment of wood ceased after a few years. Probable reasons are that the prepolymer is toxic, there are limits to resin weight percent gain that restrict the property increases, UF resins are susceptible to hydrolysis by water, and there is the potential of formaldehyde release from the product.

Nonetheless, urea remains an attractive chemical for wood improvement because of its non-toxicity, low price and ease of use. As a result, since the 1980s the inventors have been trying to find ways to overcome the disadvantages of UF treated wood.

Furfural (C₆H₄O₂) is derived from plant material containing pentosans (five (5) carbon sugars) by acid hydrolysis. Oat hulls, sugar cane bagasse and corncobs are the major industrial sources of furfural although wood and bark also can be used. Hardwoods are higher in pentosans than softwoods and therefore have higher furfural yield. Birch is particularly high in pentosans and has the highest yield among wood species. Furfural is one of the breakdown chemicals of biomass in nature. It is found in foods that contain cooked or fermented sugars and it can be added to foods as a flavoring.

Furfural is usually converted into furfuryl alcohol if a resin is to be made from it because furfural alone does not resinate usefully but furfuryl alcohol does easily. As an aldehyde, furfural can undergo many of the same reactions as formaldehyde. Thus it becomes a candidate for reaction with urea to make resins. In the patent and technical literature, there are many descriptions of resins made using furfural, some with urea included, but all with other major reactants such as phenol included.

There was work done on furfural-urea (FUR) resins in the early 20^{th} century (e.g. p 669-670 of The Chemistry of Synthetic Resins by Carleton Ellis, Reinhold Publishing, 1935). It was later mentioned in another textbook (p 119 of Urea-Formaldehyde Resins by Beat Meyer, Addison Wesley Publishing Company, 1979). FUR resins were mentioned as wood stabilization compounds in a 1960 article, but no data on properties or methods of preparation were mentioned (Weaver, JW, JF Neilson and LS. Goldstein. 1960. Dimensional stabilization of wood with aldehydes and related compounds. FPJ June pp 306-310).

It would be very advantageous to provide a furfural-urea (FUR) resin that is free of phenols and capable of being absorbed by wood in sufficient amounts to enhance the mechanical and structural properties of the wood.

### SUMMARY OF THE INVENTION

In accordance with an embodiment of the present invention there is provided a method for modification of wood, comprising the steps of:

method for modification of wood, comprising the steps of:

a) impregnating wood with furfural; thereafter

b) impregnating the wood with a solution of urea, water and an effective acidic catalyst for polymerizing a mixture of furfural and urea in the wood; and

c) curing the polymerized mixture of furfural and urea in the wood thereby producing a modified wood.

In an embodiment, the acidic catalyst is maleic anhydride.

In another embodiment there is provided a method for modification of wood, comprising the steps of:

a) impregnating wood with an aldehyde selected from the group consisting of acetaldehyde, propionaldehyde, n-butyraldehyde, isobutyraldehyde, n-valeraldehyde, isovaleraldehyde, n-caproaldehyde, acrolein (propenal), crotonaldehyde, gluteraldehyde and benzaldehydel; thereafter

b) impregnating the wood with a solution of urea, water and an effective acidic catalyst for polymerizing a mixture of aldehyde and urea in the wood; and

c) curing the polymerized mixture of aldehyde and urea in the wood thereby producing a modified wood.

### DETAILED DESCRIPTION OF THE INVENTION

The methods described herein are generally directed to wood impregnants produced from furfufural-urea-organic acid/anhydride mixtures and methods of producing wood containing polymers of these impregnants. Although embodiments of the present invention are disclosed herein they are merely exemplary.

Therefore, the specific chemical and functional details disclosed herein are not to be interpreted as limiting but merely as a basis for the claims and as a representative guide for enabling those skilled in the art to employ the present invention in a variety of manner. For purposes of instruction and not limitation, the illustrated embodiments are all directed to embodiments of wood impregnants produced from furfufural-urea-organic acid/anhydride mixtures and to methods of producing wood containing polymers of these impregnants.

As used herein, the term “about”, when used in conjunction with ranges of concentrations of constituents of various formulations or other physical properties or characteristics, is meant to cover slight variations that may exist in the upper and lower limits of the ranges of concentrations as to not exclude embodiments with concentrations slightly above or below those recited herein. It is not the intention to exclude embodiments such as these from the present invention.

As used herein, the term “resin” refers to a high molecular weight substance or pre-polymer that will subsequently be reacted to form a polymer.

The inventors have been studying furfural-urea (FUR) wood impregnation formulations in order to develop formulations that can easily be impregnated into wood and polymerized therein such that it would usefully improve wood properties such as hardness, mechanical properties and biodeterioration resistance. The inventors have been successful in developing cross linked FUR resins with desirable properties as disclosed in copending U.S. patent application Ser. No. 11/819,950 filed concurrently herewith entitled “FURFURAL-UREA RESIN AND ADHESIVE AND THEIR METHODS OF PRODUCTION”, which is incorporated herein by reference in its entirety.

However, there are several challenges that must be overcome before useful impregnating solutions for wood can be developed. The challenges are different for high loadings than for low loadings. High loadings can potentially impart large physical property improvements and dark color. Low loadings have the potential to improve biodeterioration resistance at low cost and imparting medium brown to reddish brown color, depending upon species and loading.

Copending U.S. patent application Ser. No. 11/819,951 filed concurrently herewith entitled “WATERBORNE FURFURAL-UREA MODIFICATION OF WOOD”, which is incorporated herein by reference in its entirety discloses methods for low polymer loadings of wood.

The present invention is directed to methods and compositions for high polymer loadings of wood using catalyzed furfural and urea mixtures. Making high polymer loading modified wood requires using undiluted or slightly diluted monomers. These monomers must be able to penetrate the wood well. When these monomers are converted to a polymer inside the wood, they produce high polymer weight percent gain (WPG) because most or all of the impregnating solution is converted to a polymer.

These catalyzed furfural-urea mixtures react strongly and produce a hard, water-insoluble, methanol-insoluble thermosetting resin which are desirable properties for modifying wood. Having a low-molecular weight formulation that impregnates well into wood and then can be converted to a polymer is the usual method for making polymer-modified wood. However, the furfural-urea reaction is so fast and strong that the mixture tends to solidify too soon to be a useful polymerizable wood impregnant. So while the initial fluidity and reactivity of the solution along with the desirable properties of the polymer showed promise for making modified wood, the solution is not stable enough to be used in the normal way. The challenge was to determine how to use the combination of furfural and urea to make a useful, high-concentration treating solution for wood.

The method discovered by the inventors and disclosed herein is to first impregnate the wood with furfural alone (neat). An empty cell process (with no initial vacuum, pressure and long final vacuum) is used in an attempt to give deep penetration with limited furfural uptake. A second impregnation is then carried out with a solution of urea and an acidic catalyst (for example maleic anhydride) in water using a full cell process (with initial vacuum, pressure, short final vacuum). The wood is then dried, which may be achieved using a normal kiln schedule (with steps up to about 100° C.). During drying from very wet to below fiber saturation point (below about 30% moisture content), the furfural-urea mixture cures to a cross-linked, insoluble polymer in the wood. Preferably the process of curing is carried out at a temperature in a range from about 40° C. to about 100° C. The wood so modified is very dark colored. Hardwood rays are observed to be as dark as the longitudinal tissue surrounding them. The FUR modified wood is very similar to wood modified by undiluted, catalyzed furfuryl alcohol solutions, except that rays are not normally as dark when using the furfuryl alcohol solution. For a similar weight percent gain, the FUR treated wood according to the present invention appears darker and more uniformly colored than wood modified with furfuryl alcohol. Curing occurs at a lower temperature than required for furfuryl alcohol treatments.

Another method of application is to spray, curtain coat, dip, soak (at atmospheric pressure) one solution onto the wood surface and follow it with an application by one of these methods with the second solution. Heat curing would then produce a surface-treated material.

Without being limited to any theory, it is believed by the inventors that the key function of the aldehyde is to react with the urea to produce the resin, so those skilled in the art will appreciate that many aldehydes and combinations of them may be used including acetaldehyde, propionaldehyde, n-butyraldehyde, isobutyraldehyde, n-valeraldehyde, isovaleraldehyde, n-caproaldehyde, acrolein (propenal), crotonaldehyde, gluteraldehyde and benzaldehyde.

Furfural is a preferred aldehyde for this invention because of its good reactivity, ability to form a strong polymer, and relatively low volatility. Furthermore, furfural is made from renewable resources such as plant tissue, particularly agricultural residues.

A preferred formulation for the constituents of the catalyst solution used for impregnation into the wood after the neat furfural has been impregnated is shown in Table 1. It is to be understood that the ranges shown herein are only exemplary and that the present invention is not limited to these ranges.

The solution impregnated into the wood after the furfural needs to be acidic to react with the furfural. Other organic anhydrides and acids, such as citric acid, have been shown to be effective acidic catalysts. A preferred acidic catalyst is maleic anhydride. Strictly speaking, maleic anhydride is not an acid, but it does impart an acidic effect (low pH) to the formulation. Thus, as used herein, the phrase “acidic catalyst” is meant to cover maleic anhydride even though it is not an acid by definition. As mentioned above, maleic anhydride is a preferred compound to obtain the needed acidity because less of it is needed than some other true acids (like citric acid) and because it is thought to be covalently incorporated into the resin rather than acting only as a catalyst. Alternative acidic catalysts that may be used include, but are not limited to: phthalic anhydride, formic acid, citric acid, or lactic acid, all of which are true acids by definition. The key function of the acidic catalyst is to make the solution mildly acidic, so those skilled in the art will appreciate that many organic acids, mineral acid salts and dilute mineral acids and combinations of them may be used including dilute sulfuric acid, dilute hydrochloric acid, zinc chloride and ferric chloride.

Table 2 gives the fluid loadings and concentrations of reactants in the wood based on ovendry wood weight for the two impregnations (furfural followed by the urea and catalyst solution). The solution concentrations of the reactants in the wood, on a solution rather than ovendry wood basis, are shown in Table 3.

Since furfural has one reactive group per molecule while urea has two reactive groups per molecule, 2 moles of furfural is required for one mole of urea to form an ideal resin. The molecular weight of furfural is 96 g/mole and urea is 60 g/mole. Thus a stoichiometric mixture would be 76 g furfural to 24 g urea. Practice has shown that an excess of furfural facilitates resin formation. The solutions used for treating wood had an excess of furfural over urea. Solubility studies of the FUR modified wood indicate that maleic anhydride becomes a part of the resin. Without the maleic anhydride (or another acid), the mixture does not polymerize well.

TABLE 1
Formulation for the urea and catalyst treating solution (used as
an impregnant following neat furfural).
Parts by weight

| Water | Urea | Maleic anhydride |
|---|---|---|
| 100 | 15 to 20 | 15 to 20 |

TABLE 2
Fluid loading of treating solutions in wood and their
composition based on dry wood weight.

| | % fluid loading | | Parts per | | |
|---|---|---|---|---|---|
| | of wood | | 100 parts of wood | | |
| | | Catalyst | | | Maleic |
| | Furfural | mixture | Furfural | Urea | anhydride |
| Southern pine | 64 | 68 | 64 | 10 | 10 |
| Beech | 40 | 67 | 40 | 10 | 10 |

TABLE 3
Parts reactants (solution basis) in the reacting mixtures inside
wood.

| | Furfural | Urea | Maleic anhydride |
|---|---|---|---|
| Southern pine | 76 | 12 | 12 |
| Beech | 66 | 17 | 17 |

Some properties of the FUR modified wood are given in Table 4. The hardness of the modified wood is increased, the wood is darker colored and there is a reduction in water swelling (as measured by the percent antiswell efficiency) compared to untreated wood. Higher polymer loadings of pine resulted in higher ASE (less swelling).

TABLE 4
Properties of wood treated with furfural and then urea with
catalyst and then kiln dried.

| | Specific | Polymer | ASE in | | | |
|---|---|---|---|---|---|---|
| Wood | gravity | WPG | water | Shore D hardness | | |
| type | Untreated | (%) | (%) | Untreated | Treated | Color |
| Southern | 0.5 | 25 | 25 | | | Brown |
| pine | | | | | | to dark |
| | | | | | | brown |
| Southern | 0.5 | 50-60 | 36 | | | Black |
| pine | | | | | | |
| Beech | 0.6 | 45 | 15 | 63-70 | 80-85 | Black |

Curing was accomplished during the drying process. A normal kiln drying schedule with temperatures below the boiling point of water was used. Curing efficiencies were determined by comparing the fluid loading and concentration of theoretical solids to the polymer weight percent gain. Efficiencies were in the 85% to high 90% range. The lower end of the range was for small blocks and the higher for larger samples. Lumber would be at the higher end of the range because of its low surface-to-volume ratio compared to small samples. Modified wood produced by the present method is characterized in that it exhibits a polymer weight percent gain in the 25% to 95% range.

It would be understood by those skilled in the art that heat for curing can be supplied in many ways, including but not limited to hot air, steam, hot press platens, infrared and high frequency radiation (microwaves and radio frequency).

A lightening of color was observed with distance into the samples. This suggests that there is a decrease in polymer loading with distance into the wood that the treatment chemical travels.

There are several advantages of the method of treatment of wood disclosed herein. The method is simple and uses plant-derived chemicals as its major constituents. Rays in hardwoods are treated as well as the longitudinal cells, producing an aesthetically pleasing look to the treated wood. Very dark colors of the treated wood can be achieved. The curing occurs during a normal, below-water-boiling-point drying schedule.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

Zeitsch, K. J 2000. The chemistry and technology of furfural and its many by-products. ACS Sugar series, 13. Elsevier Science BV. p 358. The Chemistry of Synthetic Resins by Carleton Ellis, Reinhold Publishing, 1935
Weaver, J W, J F Neilson and L S. Goldstein. 1960. Dimensional stabilization of wood with aldehydes and related compounds. Forest Products Journal, June, pp 306-310.

Therefore what is claimed is:

1. A method for modification of wood, comprising the steps of:
a) impregnating wood with furfural; thereafter
b) impregnating the wood with a solution of urea, water and an effective acidic catalyst for polymerizing a mixture of furfural and urea in the wood; and
c) curing the polymerized mixture of furfural and urea in the wood thereby producing a modified wood.

2. The method according to claim 1 wherein said effective acidic catalyst is maleic anhydride.

3. The method according to claim 1 wherein said acidic catalyst is selected from the group consisting of maleic anhydride, phthalic anhydride, formic acid, citric acid, lactic acid, organic acids, mineral acid salts, dilute mineral acids, dilute sulfuric acid, dilute hydrochloric acid, zinc chloride and ferric chloride.

4. The method according to claim 2 wherein said water is present in an amount of about 100 parts by weight, said urea is present in an amount from about 15 to about 20 parts by weight, and said maleic anhydride is present in an amount from about 15 to about 20 parts by weight.

5. The method according to claim 1 wherein said step c) of curing (polymerizing) the mixture of furfural and urea in the wood is achieved by heating the wood.

6. The method according to claim 5 wherein heat for curing the mixture is supplied by any one or combination of hot air, steam, hot press platens, infrared and high frequency radiation.

7. The method according to claim 1 wherein said step c) of curing is carried out at a temperature in a range from about 40° C. to about 100° C.

8. The method according to claim 2 wherein said step c) of curing is carried out at a temperature in a range from about 40° C. to about 100° C.

9. The method according to claim 3 wherein said step c) of curing is carried out at a temperature in a range from about 40° C. to about 100° C.

10. The method according to claim 4 wherein said step c) of curing is carried out at a temperature in a range from about 40° C. to about 100° C.

11. The method according to claim 5 wherein said step c) of curing is carried out at a temperature in a range from about 40° C. to about 100° C.

12. The method according to claim 1 wherein said step a) is performed using an empty-cell procedure, and wherein said step b) is performed using a full-cell process.

13. The method according to claim 2 wherein said step a) is performed using an empty-cell procedure, and wherein said step b) is performed using a full-cell process.

14. The method according to claim 3 wherein said step a) is performed using an empty-cell procedure, and wherein said step b) is performed using a full-cell process.

15. The method according to claim 4 wherein said step a) is performed using an empty-cell procedure, and wherein said step b) is performed using a full-cell process.

16. The method according to claim 5 wherein said step a) is performed using an empty-cell procedure, and wherein said step b) is performed using a full-cell process.

17. The method according to claim 1 wherein said modified wood is characterized in that it exhibits a polymer weight percent gain in the 25% to 95% range.

18. The method according to claim 2 wherein said modified wood is characterized in that it exhibits a polymer weight percent gain in the 25% to 95% range.

19. The method according to claim 7 wherein said modified wood is characterized in that it exhibits a polymer weight percent gain in the 25% to 95% range.

20. A modified wood produced using the method of claim 1.

21. A modified wood produced using the method of claim 2.

22. A modified wood produced using the method of claim 4.

23. A modified wood produced using the method of claim 7.

24. A modified wood produced using the method of claim 12.

25. A method for modification of wood, comprising the steps of:
a) impregnating wood with an aldehyde selected from the group consisting of acetaldehyde, propionaldehyde, n-butyraldehyde, isobutyraldehyde, n-valeraldehyde, isovaleraldehyde, n-caproaldehyde, acrolein (propenal), crotonaldehyde, gluteraldehyde and benzaldehydel; thereafter
b) impregnating the wood with a solution of urea, water and an effective acidic catalyst for polymerizing a mixture of aldehyde and urea in the wood; and
c) curing the polymerized mixture of aldehyde and urea in the wood thereby producing a modified wood.
